(19) United States
(12) Patent Application Publication
(10) Pub. No.: US 2005/0115305 A1
(43) Pub. Date: Jun. 2, 2005

(54) Leak detection method and devices

(76) Inventors: Markus Nothhelfer, Wertheim-Dorlesberg (DE); Andreas Seiler, Wertheim-Dorlesberg (DE)

Correspondence Address: WALL MARJAMA & BILINSKI, 101 SOUTH SALINA STREET, SUITE 400, SYRACUSE, NY, 13202, US

(21) Appl. No.: 10/497,477

(22) PCT Filed: Jan. 9, 2003
(86) PCT No.: PCT/EP03/00120

(30) Foreign Application Priority Data
Jan. 18, 2002 (DE) 10201757.3

(51) Int. Cl. G01M 3/04

(52) U.S. Cl. 73/41

(57) ABSTRACT

A method for investigation of essentially similar samples for leaks, whereby the samples are introduced to a leak detection device by means of a transport device. The samples are investigated for leaks and removed by means of a transport device. An “in-line” leak investigation of the samples may be carried out in which each sample is placed in one of several test chambers that are located on a circular support. During the rotation of the support, the leak test is first prepared and then carried out, and finally the sample is removed from its respective test chamber and taken away.

The present invention relates to a method and devices for investigating samples as to leaks.

In a multitude of series manufactured products with packagings, encapsulations, housings or alike, there frequently exists the requirement of ensuring their leak tightness. Products, respectively samples of this kind are, for example, packaged products (foodstuffs, pharmaceuticals, sterile items usable only once etc.) be it that the packaging consists of a foil or a bottle, respectively an ampoule with seal. In this instance the leak tightness of the packaging is of interest. Series manufactured products in which the leak tightness plays an important role may also be encapsulated components (electronics components, switches or alike) or other items exhibiting a more or less large hollow chamber (encapsulated machine components, gas cartridges, gas generators . . . ).

From DE 196 42 099 A1 it is known to test the packaging of a packaged item as to leak tightness. This test is performed according to the principle of vacuum leak detection in a test chamber being formed by two extensible foils. Introduction into, respectively removal of the sample from the device is performed manually. When employing leak detection devices of this kind in manufacturing processes with short cycle times, leak detection may only performed on random samples for the purpose of being able to detect system malfunctions as early as possible. Disadvantageous here is that the measures for remedying such malfunctions carry the penalty of a considerable time delay. The investigation of as many as possible, or even all samples manufactured with short cycle times is not possible.

From U.S. Pat. No. 5,373,729 a device is known with which the packaging of containers, each sealed with a foil, is tested for leak tightness. The test is performed “in-line”, i.e. each of the containers is investigated as to a possibly existing leak. In order to permit this type of test, the containers are introduced to the leak detection device by means of a transport device. The leak detection device itself consists of a lower section and an upper section being movable upwards and downwards. Located between these components is the transport device which is stopped for the period of time during which the leak detection is performed. Leak detection at cycle frequencies in the seconds range is not possible.

It is the task of the present invention to create methods and devices of the aforementioned kind which allow for a leak detection on samples at high cycle frequencies so that also for products manufactured at cycle frequencies approximately in the seconds range, an “in-line” leak investigation is possible.

This task is solved by the present invention through the measures in accordance with the patent claims.

By applying the gymwheel principle it is possible to create test chambers at a relatively high cycle frequency and for a sufficiently long period of time during which the leak detection can be prepared and performed. Here the gymwheel principle is to be understood such that besides the items which are to be analysed for leaks on the transport device there exists a substantially circular rotating device, basically known from other applications, where said device is equipped with the test chambers. Into these, the items are introduced. During a revolution of the system the leak detection process takes place. If the number of test chambers formed per unit of time does not exceed the number of samples manufactured per unit of time, an in-line leak detection may be performed, provided the test chambers can be maintained in the closed state for a sufficiently long period of time. Relevant for the number of test chambers required is here the time interval at which the samples are being manufactured and the time within which a leak detection can be performed. If samples are created at high cycle frequencies, for example one sample per second, and if performing of the leak test takes approximately 10 seconds, then 12 test chambers will be required when the samples can be introduced within one second into a test chamber and removed therefrom.

Further advantages and details of the present invention shall be explained with reference to schematically depicted examples of embodiments in the drawing figure. The drawing figure depicts a solution in which a multitude of test chambers is located on a circular support rotatable about a vertical axis.

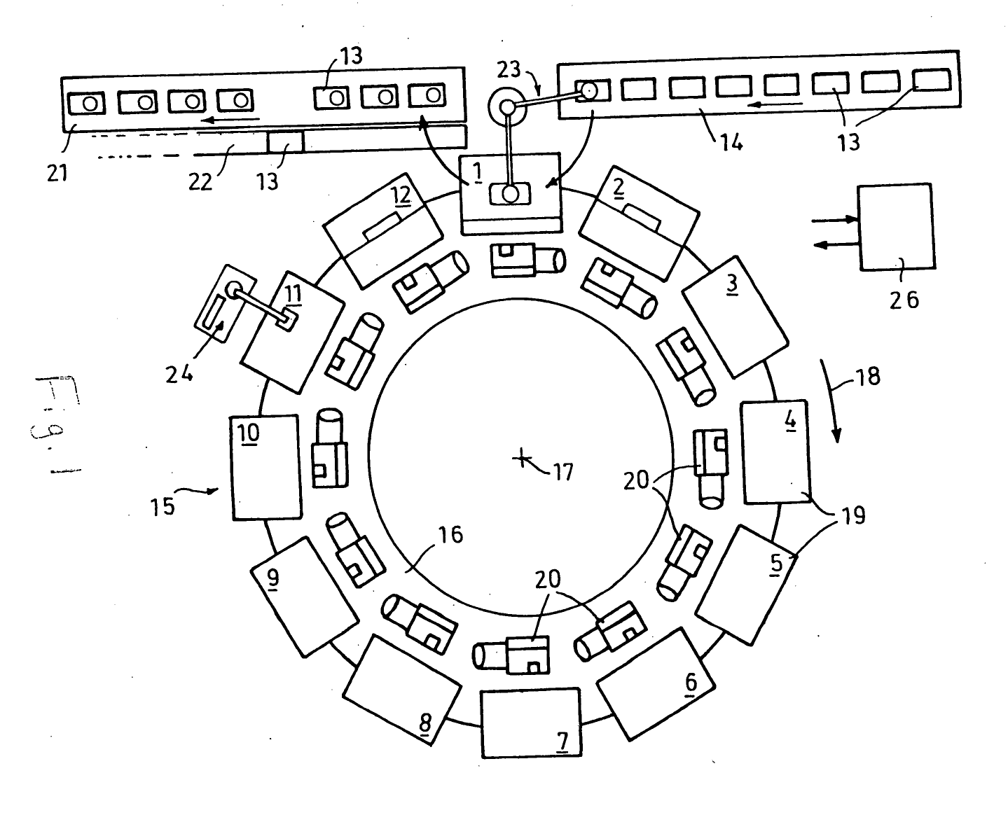

In the solution according to drawing FIG. 1, the samples 13 are introduced to a leak detection device 15 by means of a transport device 14. Said leak detection device consists of a circular disk-shaped or circular ring-shaped support 16 which is suspended in a manner not depicted in detail rotatable about the vertical axis 17 (arrow 18). Located on the support 16 are 12 leak detection chambers 19 arranged in a circle. 1 to 12 designate stations through which each of the leak detection chambers 19 passes. The leak detection chambers 19 of stations 3 to 11 are depicted in the closed state, the chambers of stations 2 and 12 in the half opened state and the chamber of station 1 in the opened state. To each of the leak detection chambers 19 there is assigned a vacuum pump 20, which is connected through lines with valves, not depicted, to the corresponding leak detection chamber. Two transport devices 21 and 22 serve the purpose of moving the samples 1 detected for leaks away. Transport device 21 serves the purpose of moving leak tight samples 1 away. Samples which exhibit a leak are deposited on the transport device 22.

The leak detection chambers 19 are expediently designed such as detailed in DE-A-196 42 099. The test chamber is formed by two extensible foils which are each clamped into a frame. The sample which is to be tested for leaks is introduced between the foils. Thereafter the intermediate space is evacuated so that a leak detection chamber is created directly encompassing the item. The foils are equipped with means (naps, porous coating or alike) which form a contiguous intermediate chamber between the foils and the area of the item to be tested. This intermediate chamber is connected to a detector sensitive to the test gas. It is not absolutely mandatory that two foils form the test chamber; a foil clamped into a frame and a solid bottom section (or cover section) may also employed for creating a test chamber having a small residual volume.

The leak test sequence is performed such that a pick-and-place device 23 grips—with a vacuum suction device, for example—the supplied samples 13 and introduces the samples into the opened leak detection chamber 19 of the station 1. The chamber 19 dwells at this station 1 for approximately one second. In one second intervals the chambers 19 are transported on to the next respective station. At the level of the station 2 the chamber closes. Immediately thereafter the evacuation commences.

It is expedient to commence a gross leak detection already relatively soon after having started the pump down phase. In this manner massive leaks, caused by an air inrush in the instance of a burst sample, for example, may be determined. During the process of precision leak detection (station 11) such leaks can no longer be determined, since at this point of time also the test gases contained in the sample have been pumped out. Gross leak detection is performed, for example, in that at the level of the station 5 a sensor sensitive to the test gas is queried, said sensor being connected to the connecting lines between the chambers and their vacuum pumps.

The pump down process is continued up to station 10 and there reaches a pressure of approximately 1 mbar. At the level of the station 11, a sensitive leak detection device 24 is linked to the chamber 19. Said leak detection device is equipped with a test gas detector being designed by way of a mass spectrometer. With it thus leaks down to 10⁻⁹ mbar l/s can be determined. Through the station 12, in which opening of the chamber is performed, the chamber reaches the station 1. The pick-and-place device 23 removes the sample 1 from the chamber 19 and places the sample on one of the two transport devices 21, 22, depending on whether the sample is leaktight or not.

In drawing FIG. 1 also the controller of the leak detection device is depicted by way of block 26. Due to the multitude of moving parts, communication between the controller 26 and the components to be controlled (transport devices, valves, support 16, pick-and-place device 23 etc.) on the one hand and the signal sources (gross leak detection, leak detector 24) and the controller 26 on the other hand, is effected expediently by means of an infrared data acquisition system.

1-11. (canceled)

12. Continuous investigation of samples as to leaks by application of the gymwheel principle.

13. A method for investigation of essentially similar samples for leaks comprising the steps of:
introducing samples to a test chamber by means of a transport device,
investigating said samples for leaks; and
removing said samples by means of a transport device in which each sample is placed in one of several test chambers located on a rotatable circular support and where during the rotation of the support, a leak test is first prepared and then carried out and wherein the sample is finally removed from a respective test chamber and taken away.

14. Method according to claim 13, wherein the circular support is a horizontal gymwheel that rotates about a substantially vertical axis.

15. Method according to claim 13, further including a test gas leak detection step that is performed in which the samples contain test gas and said leak detection step is effected such that gas within at least one test chamber is investigated with the aid of a test gas detector for the presence of test gas.

16. Method according to claim 13, wherein the test chambers by way of a cycle pass through several stations and where after said introducing step, an evacuation step in which an evacuation of the chamber is initially performed.

17. Method according to claim 16, wherein during the evacuation step, a gross leak detection is performed wherein a test gas sensitive sensor is queried, said sensor being located in connection line between the chamber and a vacuum pump.

18. Method according to claim 16, including the step of linking a test gas sensitive detector to the chamber at the level of the last stations of said cycle.

19. Device for performing the method according to claim 13, further including a circular support with a multitude of test chambers spread along the circumference of the support and supply and removal means for supplying and removing the items which are to be investigated.

20. Device for implementing the method according to claim 19, wherein a vacuum pump is assigned to each of the leak detection chambers.

21. Device for implementing the method according to claim 19, wherein each of the leak detection chambers includes two wall sections that are movable with respect to each other, said wall sections in the joined state forming the chamber accepting the item to be tested and where at least one of the wall section is an extensible foil.

22. Device for implementing the method according to claim 19, further comprising a controller and an infrared data acquisition system permitting the controller to communicate with components to be controlled.
